(19) United States
(12) Patent Application Publication
(10) Pub. No.: US 2014/0005971 A1
(43) Pub. Date: Jan. 2, 2014

(54) LIKELIHOOD-BASED SPECTRAL DATA PROJECTION DOMAIN DE-NOISING

(71) Applicants: Ewald Roessl, Ellerau (DE); Roland Proksa, Neu Wulmstorf (DE)

(72) Inventors: Ewald Roessl, Ellerau (DE); Roland Proksa, Neu Wulmstorf (DE)

(73) Assignee: KONINKLIJKE PHILIPS N.V., EINDHOVEN (NL)

(21) Appl. No.: 14/005,041

(22) PCT Filed: Mar. 2, 2012
(86) PCT No.: PCT/IB2012/050985

§ 371 Date: Sep. 13, 2013

Related U.S. Application Data
(60) Provisional application No. 61/452,825, filed on Mar. 15, 2011.

(51) Int. Cl. G01T 7/00

(52) U.S. Cl. CPC G01T 7/005
USPC 702/104

(57) ABSTRACT

A method for processing projection data in the projection domain includes receiving the projection data. The projection data is generated by a spectral detector and includes two or more independent energy-resolved measurements in which at least one of the two or more measurements has first photon statistics. The method further includes generating a de-noised measurement in electronic format for the at least one of the two or more measurements having the first photon statistics. The de-noised measurement has second photon statistics which are better than the first photon statistics.

### FIELD OF THE INVENTION

The following generally relates to spectral imaging and more particularly to de-noising spectral data in the projection domain, and is described in connection with spectral computed tomography (CT).

### BACKGROUND OF THE INVENTION

A conventional computed tomography (CT) scanner includes a rotating gantry rotatably mounted to a generally stationary gantry. The rotating gantry supports an x-ray tube and a detector array, which is mounted on the rotatable gantry opposite the x-ray tube, across an examination region. The rotating gantry and hence the x-ray tube and the detector array rotate around the examination region about a longitudinal or z-axis. The x-ray tube is configured to emit radiation that traverses the examination region (and a portion of a subject or object in the examination region) and illuminates the detector array. The detector array detects the radiation and generates projection data (detection measurements) indicative of the examination region and the subject or object disposed therein. A reconstructor reconstructs the projection data, generating volumetric image data. An image processor can process the volumetric image data and generate one or more images of the scanned portion of the subject or object.

For spectral CT, the scanner may include two x-ray tubes configured to emit different energy spectrums or an x-ray tube configured to switch between at least two different energy spectrums, and/or the detector array may include an energy-resolving detector array with spectral or photon counting detectors. A double decker spectral detector has a first detection layer configured to detect lower energy photons and a second detection layer configured to detect higher energy photons. The first and second detection layers are arranged with respect to each other such that the first detection layer is above the second detection layer and nearer to the x-ray tube along a direction of the radiation from the x-ray tube to the detector array. Each detection layer includes a scintillator/photodiode pair, in which the scintillator receives and absorbs an x-ray photon and emits a light photon indicative thereof, and the photosensor detects the light photon and generates a detection measurement indicative of the energy of the initial x-ray photon.

Where the scanner includes a single x-ray tube configured to switch between two emission spectrums (e.g., 80 kVp and 140 kVp) and a double decker spectral detector, the projection data will include four (4) independent energy-resolved detection measurements, respectively corresponding to (1) 80 kVp and the first detection layer, (2) 80 kVp and the second detection layer, (3) 140 kVp and the first detection layer, and (4) 140 kVp and the second detection layer. With the lower x-ray tube voltage of 80 kVp, the first detection layer will absorb most of the photons and the second lower detection layer will register relatively few counts, and the energy-resolved measurements produced by the corresponding photodiode will have poor photon statistics. (The photon statistics can be improved by increasing x-ray tube current; however, this will increase patient dose, or exposure to ionizing radiation.) Likewise, a narrow energy bin channel of a counting detector will produce measurements with poor photon statistics. Unfortunately, when processing such measurements, for example, using a basis-material decomposition, the poor photon statistics will result in disproportionate basis-material decomposition noise.

### SUMMARY OF THE INVENTION

Present aspects of the application provide a new and improved spectral CT technique that addresses the above-referenced problems and others.

In accordance with one aspect, a method for processing projection data in the projection domain includes receiving the projection data. The projection data is generated by a spectral detector and includes two or more independent energy-resolved measurements in which at least one of the two or more measurements has first photon statistics. The method further includes generating a de-noised measurement in electronic format for the at least one of the two or more measurements having the first photon statistics. The de-noised measurement has second photon statistics which are better than the first photon statistics.

According to another aspect, a system includes a projection data processor that receives projection data generated by an imaging system and including two or more independent energy-resolved measurements in which at least one of the two or more measurements has first photon statistics, and de-noises the measurement for the at least one of the two or more measurements having the first photon statistics, wherein the de-noised measurement has second photon statistics which are better than the first photon statistics.

According to another aspect, a method includes processing projection data generated by a radiation sensitive detector so as to equalize noise of lower and higher photon statistic spectral measurements of the projection data based on minimizing a likelihood of the projection data in the projection domain.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention.

FIG. 1 schematically illustrates an example imaging system in connection with a projection data processor that at least de-noises energy-resolved measurements of the projection data.

FIG. 2 schematically illustrates an example of the projection data processor.

FIG. 3 graphically illustrates an example profile of energy-resolved detection measurements having poor photon statistics and an example profile of a version of the energy-resolved detection measurements having the poor photon statistics after de-noising by the projection data processor.

FIG. 4 graphically illustrates an example profile of energy-resolved detection measurements having good photon statistics and an example profile of a version of the energy-resolved detection measurements having the good photon statistics after de-noising by the projection data processor.

FIG. 5 illustrates a method for de-noising projection data in which at least a sub-portion of energy-resolved detection measurements of the projection data have poor photon statistics.

### DETAILED DESCRIPTION OF EMBODIMENTS

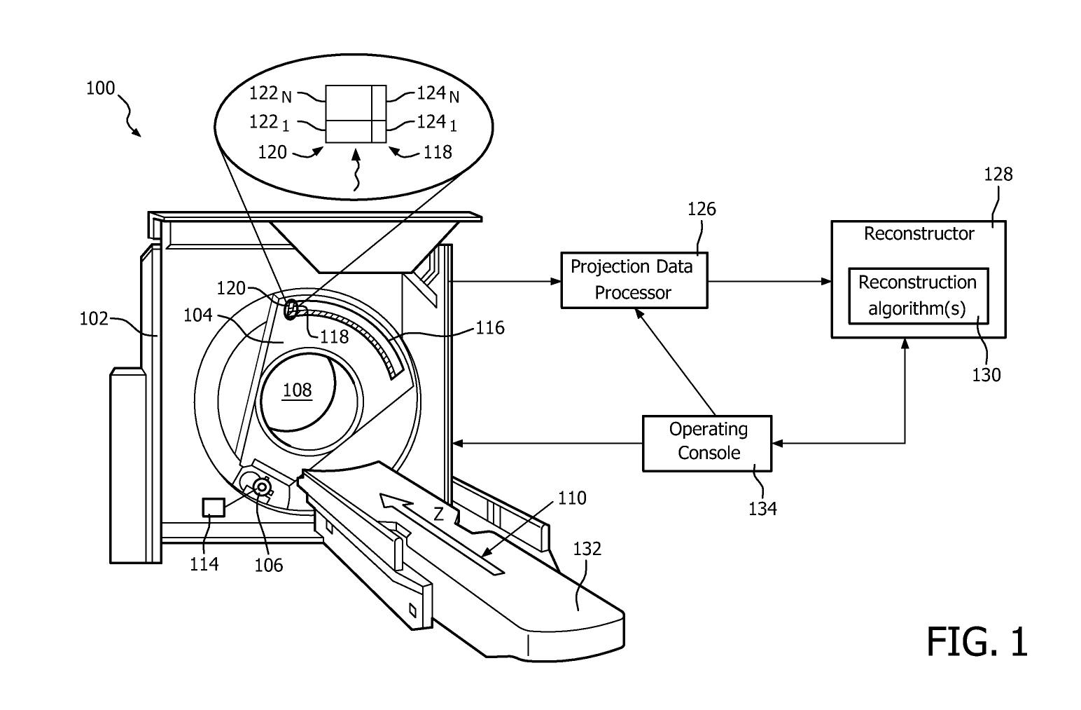

FIG. 1 schematically illustrates an imaging system 100 such as a computed tomography (CT) scanner. The imaging system 100 includes a generally stationary gantry portion 102 and a rotating gantry portion 104. The rotating gantry portion 104 is rotatably supported by the generally stationary gantry portion 102 via a bearing (not shown) or the like.

A radiation source 106, such as an x-ray tube, is supported by the rotating gantry portion 104 and rotates therewith around an examination region 108 about a longitudinal or z-axis 110. A source collimator 112 collimates radiation emitted by the radiation source 106, producing a generally cone, fan, wedge or otherwise-shaped radiation beam that traverse the examination region 108.

A radiation source voltage controller 114 controls the mean emission voltage of the radiation source 106. In one instance, the radiation source voltage controller 114 switches or otherwise changes the emission voltage, for example, between multiple voltages in a range from 10 kVp to 160 kVp, from scan to scan, between integration periods (views) of a scan, within an integration period, and/or otherwise. As a result, radiation beams having different mean emission energy spectra can be generated and used to scan an object or subject.

By way of non-limiting example, the radiation source voltage controller 114 can be configured to switch the emission voltage between 80 kVp and 140 kVp. Under this control, the radiation source 106 emits first radiation with a first energy spectrum (80 kVp or 140 kVp) and a second radiation with a second different energy spectrum (140 kVp or 80 kVp). Alternatively, the controller 114 can control the source 106 to emit a single mean emission voltage, emission voltages other than 80 kVp and/or 140 kVp, and/or more than two different emission voltages. Additionally or alternatively, the imaging system 100 may include two or more radiation sources 106, arranged at different angular locations with respect to each other in the x/y plane (e.g., 60, 90, etc. degrees apart), where at least two of the radiation sources 106 emit radiation with different energy spectra.

A one or two dimensional energy-resolving detector array 116 subtends an angular arc opposite the examination region 108 relative to the radiation source 106 and detects radiation that traverses the examination region 108. In the illustrated embodiment, the energy-resolving detector array 116 is a spectral detector array and includes a photosensor array 118 and a scintillator array 120, which is optically coupled to the photosensor array 118 on the light sensitive side of the photosensor array 118. The energy-resolving detector array 116 is arranged in the imaging system 100 so that radiation traversing the examination region 108 impinges the scintillator array 120.

The illustrated detector array 116 includes vertical detectors having multiple sub-scintillator 122₁, . . . , 122_{N} (wherein N is equal to or greater than two), stacked in a direction of the incoming radiation, each having a different spectral sensitivity and coupled to a corresponding photosensor regions 124₁, . . . , 124_{N} of the photosensor array 118. Generally, the sub-scintillator 122₁ has geometry and material that corresponds to lower energy photons, and the sub-scintillator 122_{N} has geometry and material that corresponds to higher energy photons, and spectral sensitivities of the photosensor regions 124₁, . . . , 124_{N} of the photosensor array 118 respectively match the light emission spectrums of the sub-scintillator 122₁, . . . , 122_{N}. A non-limiting example of such a detector is described in patent application Ser. No. 11/912,673, filed Oct. 26, 2007, and entitled “Double Decker Detector for Spectral CT,” the entirety of which is incorporated herein by reference.

The energy-resolving detector array 116 generates and outputs energy-resolved projection data, which includes independent energy-resolved detection measurements. By way of example, where the emission voltage switches between two different mean emission voltages and the detector array 116 includes two sub-scintillators 122 with two different spectral sensitivities and optically coupled to corresponding photosensor layers 124, the resulting projection data will include four (4) independent energy-resolved detection measurements, representing the four (4) different combinations of two emission voltages and two detector spectral sensitivities. In embodiments with more sources 106, more or less kVp switching and/or detectors with more or less detection layers, the energy-resolved projection data may include more or less independent energy-resolved detection measurements.

In an alternative embodiment, the detector array 116 is a photon-counting detector array, which, in response to detecting a photon, generates a signal having peak amplitude indicative of the energy of the detected x-ray photon. Signal processing electronics associate the detected photon with an energy range corresponding to the energy of the detected photon. Such electronics generally include a pulse shaper that processes the signal and produces an electrical signal such as a voltage or current pulse with the peak amplitude indicative of the energy of the detected photon, a discriminator that compares the amplitude of the pulse with one or more energy thresholds set in accordance with different energy levels, a counter that counts the number of times the amplitude exceeds the threshold for each threshold, and a binner that bins detected photons into energy bins or windows based on the counts.

A projection data processor 126 is configured to process the energy-resolved projection data. As described in greater detail below, in one instance such processing includes, but is not limited to, de-noising the energy-resolved projection data in the projection domain using a likelihood-based approach. Such de-noising allows for generating projection data, for lower photon statistic channels, that is less noisy relative to the projection data for the lower photon statistic channels before the de-noising. The de-noising of projection data with higher photon statistic may result in de-noised projection data with substantially the same photon statistics or better photon statistics. In one instance, the de-noising equalizes the noise in the various acquired spectral measurements in the projection domain, prior to reconstruction.

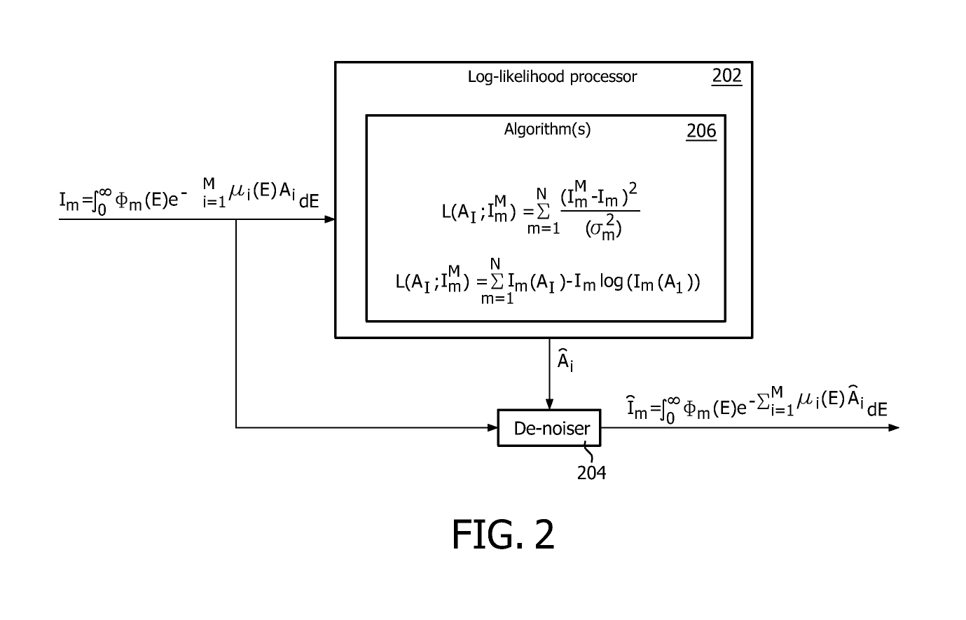

Briefly turning to FIG. 2, a non-limiting example of the projection domain processor 126 is schematically illustrated. In this embodiment, the projection domain processor 126 includes a log-likelihood processor 202, a de-noiser 204, and an algorithm(s) bank 206 with one or more algorithms accessible for use by the log-likelihood processor 202.

The log-likelihood processor 202 takes as an input the energy-resolved projection data measurements from the detector array 116 and determines a signal or value indicative of a most likely decomposition of the attenuation given the measured data based on a model for the measurement, a negative log-likelihood algorithm from the bank 206, and the measurements. The de-noiser 204 utilizes the signal to de-noise the original input energy-resolved projection data measurements, based on the model, producing de-noised energy-resolved projection data measurements.

In one non-limiting instance, the energy-resolved projection data measurements (Iₘ) can be represented via the model shown in EQUATION 1:

$${I}_{m} = {\int }_{0}^{∞} {Φ}_{m} ( E ) {e}^{- {\sum }_{i = 1}^{M} {μ}_{i} ( E ) {A}_{i}} d E , \qquad EQUATION 1$$

wherein m=1, . . . N, N represents a number of spectrally distinct measurements, Φₘ (E) represents an effective spectrum of the m^{th} measurement, μᵢ(E) represents an energy dependent attenuation basis function of the object, and Aᵢ represent line-integrals of basis material densities.

The log-likelihood processor 202 receives Iₘ and employs one of the two below negative log-likelihood algorithms of algorithm bank 206, based on the type of the energy-resolving detectors generating the measurements, to determine the most likely decomposition of the attenuation given the measurements, or Âᵢ.

Where the detector array 116 includes spectral detectors, a negative log-likelihood, based on a Gaussian noise model, can be represented (without terms independent of the quantities to be estimated) as shown in EQUATION 2:

$$L ( {A}_{I} ; {I}_{m}^{M} ) = {\sum }_{m = 1}^{N} \frac{{( {I}_{m}^{M} - {I}_{m} )}^{2}}{( {σ}_{m}^{2} )} . \qquad EQUATION 2$$

Where the detector array 116 includes photon counting detectors, a negative log-likelihood, based on a Poisson-likelihood noise model, can be represented (without terms independent of the quantities to be estimated) as shown in EQUATION 3:

$$L ( {A}_{I} ; {I}_{m}^{M} ) = {\sum }_{m = 1}^{N} {I}_{m} ( {A}_{I} ) - {I}_{m} log ( {I}_{m} ( {A}_{I} ) ) . \qquad EQUATION 3$$

The log-likelihood processor 202 determines the most likely decomposition (Âᵢ) of the attenuation given the measured data (Iₘ^{M}) by minimizing the log-likelihood equality of EQUATION 2 or EQUATION 3.

The projection data de-noiser 204 generates de-noised energy-resolved projection data measurements (Îₘ) by replacing Âᵢ with in EQUATION 1, as shown in EQUATION 4:

$${{I}^{⋒}}_{m} = {\int }_{0}^{∞} {Φ}_{m} ( E ) {e}^{- {\sum }_{i = 1}^{M} {μ}_{i} ( E ) {{A}^{⋒}}_{i}} d E . \qquad EQUATION 4$$

The de-noised energy-resolved projection data measurements (Îₘ) will, in general, differ from the initial energy-resolved projection data measurements (Iₘ^{M}) as the likelihood finds a best compromise between minimizing an overall sum in EQUATIONS 2 and 3 and satisfying single measurements.

The differences between the de-noised and initial energy-resolved measurements (Îₘ and Iₘ^{M}) will be largest for terms with large variance (σₘ²), and the variance of the de-noised energy-resolved projection data measurements (Îₘ) can be smaller than the variance of the corresponding initial energy-resolved projection data measurements (Iₘ^{M}).

It is to be appreciated that the above example is provided for explanatory purposes and is not limiting. In other embodiment, the energy-resolved projection data measurement can be otherwise modeled and/or another algorithm can be used by the log-likelihood processor 202 to determine the signal used to de-noise the projection data.

Returning to FIG. 1, a reconstructor 128 reconstructs the processed projection data and generates volumetric image data indicative of the examination region 108. The illustrated reconstructor 128 is configured to employ one or more reconstruction algorithms 130 such as a spectral decomposition algorithm, a maximum likelihood (ML) reconstruction algorithm, a filtered back-projection algorithm, an iterative reconstruction algorithm, and/or other reconstruction algorithm.

An example reconstruction algorithm models the projection data as a combination of the photo-electric effect with attenuation basis function μ_{Ph} (E), the Compton effect with attenuation basis function μ_{co} (E), and, optionally, one or more materials with attenuation basis functions μ_{K1} (E), . . . , μ_{KM}. (E), such as one or more K-edge materials. In this instance, the line-integrals of the basis-material densities of the photo-electric effect component A_{Ph}, the Compton effect component A_{Co}, and the other material components A_{K1}, . . . , A_{KM} depend in a non-linear fashion on the measurement data as expressed in EQUATION 1 above.

Where at least two detection signals are available for at least two energy ranges (e.g., photo-electric and Compton effect), a system of at least two equations is formed having two unknowns (A_{Ph} and A_{Co}), which can be solved with known numerical methods. Where at least three detection signals are available for at least three energy ranges (e.g., photo-electric effect, Compton effect, and a K-edge material), a system of at least three equations is formed having three unknowns (A_{Ph}, A_{Co}, and A_{K1}), which can be solved with known numerical methods. The results (e.g., A_{Ph} and A_{Co}, and, optionally, A_{K1}, . . . , A_{KM}), can be used alone or in combination to reconstruct images of the desired component using conventional reconstruction methods.

From above, where the emission voltage switches between two different mean emission voltages and the detector array 116 includes two sub-scintillators 122 with two different spectral sensitivities and optically coupled to corresponding photosensor layers 124, there will be four (4) independent energy-resolved detection measurements. Generally, resolution increases with the number of independent measurements available. As such, although only two of the measurements are required for two energy ranges, and only three of the measurements are required for three energy ranges, the four of the measurements can be used in both cases to improve sensitivity and noise robustness, for example, using maximum likelihood approach that takes into account noise statistics. A suitable maximum likelihood approach is described in connection with “K-edge imaging in x-ray computed tomography using multi-bin photon counting detectors,” E. Roessl and R. Proksa, 2007 Phys. Med. Biol. 52 4679-4696.

Another example reconstruction algorithm reconstructs the energy-resolved projection data into individual images and using image based analysis techniques to obtain meaningful clinical information. One non-limiting approach is to perform an N-dimensional cluster analysis to decompose the images into components such as soft tissue, calcium, iodine or other materials, where N is the number of distinct spectral measurements performed for each geometric ray.

The imaging system 100 further includes a couch or patient support 132 that supports a human or object within the examination region 108. The support 132 is movable in the x, y and z directions, which enables an operator or the system to suitably position the subject within the examination region 108 before, during and/or after scanning A computing system such as an operator console 134 facilitates user interaction with the scanner 100. Software applications executed by the operator console 134 allow the user to configure and/or control operation of the scanner 100. For instance, the user can interact with the operator console 134 to select a protocol that includes kV switching, energy-resolved detection, and/or spectral reconstruction.

It is to be appreciated that the projection data processor 126 can be implemented via one or more processors executing one or more computer readable instructions encoded on computer readable storage medium (e.g., physical memory) and/or carried in a signal. In addition, the projection data processor 126 can be part of the system 100 (as shown), for example, part of the console 134, the reconstructor 128, a separate component, etc. and/or remote from the system 100, for example, part of a computing system or distributed across computing systems. Moreover, the algorithm bank 206 may be local (as shown) or remote and may include one or both of the algorithms.

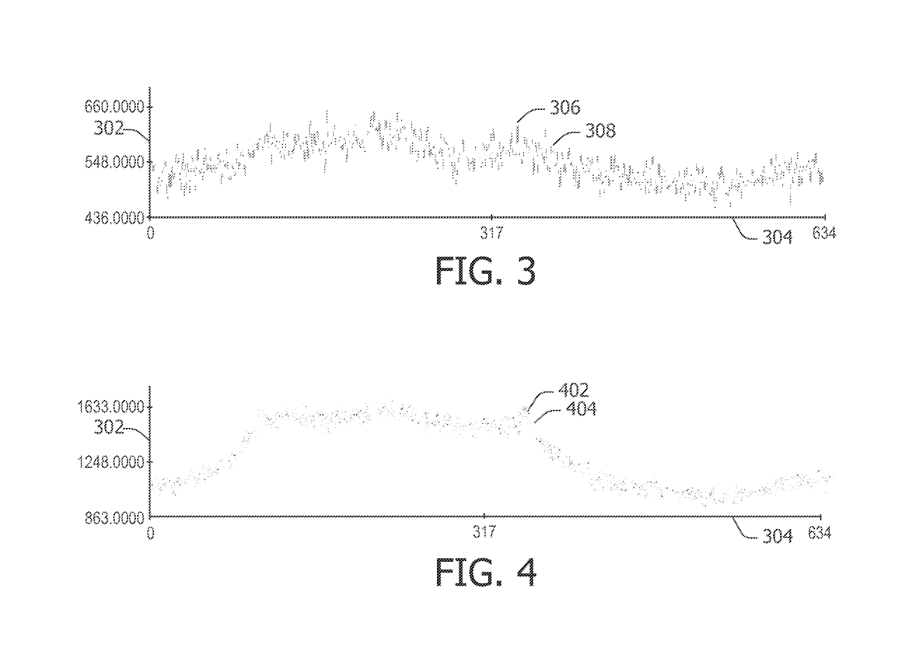

FIGS. 3 and 4 graphically show initial and de-noised energy-resolved detection measurements in connection with a multi-bin photon counting detector. In both figures, a y-axis 302 represents projection data measurements in units of absolute counts and an x-axis 304 represents detector channels of a row of detectors.

In FIG. 3, profile 306 represents initial energy-resolved detection measurements for measurements of a poor photon statistic bin (i.e., small energy window with few counts and low statistics), and profile 308 represents a log likelihood de-noised version of the profile 306 generated by the projection data processor 126 (FIGS. 1 and 2). Note that the profile 308 for the de-noised measurements is, visibly, much less noisy than the profile 306 for the initial poor photon statistic measurements. In this example, noise is improved by about a factor of two. In generally, the degree of improvement will depend on the original bin statistics relative to the statistics in all other bins.

In FIG. 4, profile 402 represents initial energy-resolved detection measurements for measurements of a high statistic bin (i.e., a relatively larger energy window with more counts and greater statistics), and profile 404 represents a log likelihood de-noised version of the profile 402 generated by the projection data processor 126 (FIGS. 1 and 2). Note that the profile 404 for the de-noised measurements and the profile 306 for the initial high statistic measurements have, visibly, about the same noise.

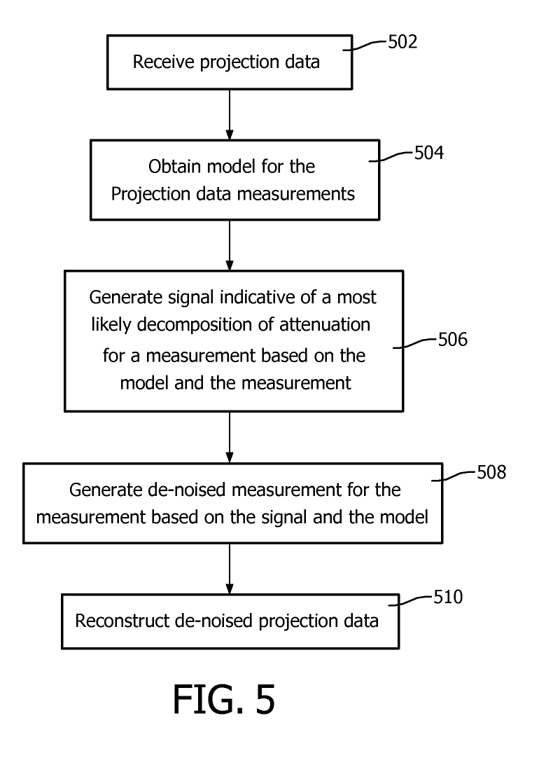

As briefly discussed in connection with FIG. 1, the detector array 116 can be an energy-resolving detector array like the one discussed in FIG. 1 or photon counting detector like the example discussed next in connection with FIG. 5. In FIG. 2, negative log-likelihoods were described for both energy-resolving detector arrays (EQUATION 2) and photon-counting detector arrays (EQUATION 3).

FIG. 5 illustrates a method for processing projection data including energy-resolved detection measurements. It is to be appreciated that the ordering of the acts in the methods described herein is not limiting. As such, other orderings are contemplated herein. In addition, one or more acts may be omitted and/or one or more additional acts may be included.

At 502, projection data is received. As discussed herein, the projection data can be generated by an energy-resolving detector and include two or more independent energy-resolved measurements in which at least one of the two or more measurements has first photon statistics.

At 504, a model representing the independent energy-resolved measurements is obtained. An example model includes the model shown in EQUATION 1. Other models can alternatively be used.

At 506, a signal indicative of a most likely decomposition of attenuation for a measurement of the independent energy-resolved measurements is generated based on the model and the corresponding measurement. This act can be performed at least on the at least one measurement having the first photon statistic and can be repeated for all or subset of the two or more independent energy-resolved measurements.

As described herein, a log-likelihood approach can be used to generate the signal. More particularly, where the energy-resolving detector is a vertical, a negative log-likelihood based on a Gaussian noise model such as the one as shown in EQUATION 2 can be used, and where the energy-resolving detector is a photon-counting detector, a negative log-likelihood based on a Poisson noise model such as the one as shown in EQUATION 3 can be used.

At 508, a de-noised measurement for the measurement is generated. The de-noised measurement can be based on the model and the signal. For example, as described herein, this can be achieved by substituting the signal into the model and computing the measurement that results in the signal, wherein the de-noised measurement has second photon statistics, which are better than the first photon statistics. This act can be performed at least on the signal corresponding to the first photon statistic and can be repeated for all or subset of the signals for the other two or more independent energy-resolved measurements.

At 510, the de-noised projection data is reconstructed.

The above may be implemented via one or more processors executing one or more computer readable instructions encoded or embodied on computer readable storage medium such as physical memory which causes the one or more processors to carry out the various acts and/or other functions and/or acts. Additionally or alternatively, the one or more processors can execute instructions carried by transitory medium such as a signal or carrier wave.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for processing projection data in the projection domain, comprising:
receiving the projection data, wherein the projection data is generated by a spectral detector and includes two or more independent energy-resolved measurements in which at least one of the two or more measurements has first photon statistics; and
generating a de-noised measurement in electronic format for the at least one of the two or more measurements having the first photon statistics, wherein the de-noised measurement has second photon statistics which are better than the first photon statistics.

2. The method of claim 1, further comprising:
generating a signal indicative of a most likely decomposition of attenuation for the at least one of the two or more measurements having the first photon statistics based on a model for the measurement and the corresponding measurement.

3. The method of claim 2, wherein the model models the measurement as a function of attenuation line integrals.

4. The method of claim 2, wherein generating the de-noised measurement includes generating the de-noised measurement based on the model and the signal.

5. The method of claim 4, wherein generating the de-noised measurement includes substituting the signal into the model and computing a measurement that results in the signal, wherein the computed measurement is the de-noised measurement.

6. The method of claim 2, wherein generating the signal includes minimizing a negative log-likelihood of the model.

7. The method of claim 6, wherein the negative log-likelihood is based on one of a Gaussian noise model or a Poisson noise model.

8. The method of claim 1, wherein the detector is the spectral detector or a photon counting detector.

9. The method of claim 1, wherein de-noising the received projection data measurement creates de-noised projection data.

10. The method of claim 9, further comprising:
reconstructing the de-noised projection data and generating volumetric image data.

11. The method of claim 10, wherein reconstructing the de-noised projection data includes performing a material-basis decomposition of the image data in which a material-basis decomposition noise for the de-noised projection data is less than a material-basis decomposition noise for a material-basis decomposition of the received projection data at least for the at least one of the two or more measurements with the first photon statistics.

12. A system, comprising:
a projection data processor that receives projection data generated by an imaging system and including two or more independent energy-resolved measurements in which at least one of the two or more measurements has first photon statistics, and de-noises the measurement of the at least one of the two or more measurements having the first photon statistics, wherein the de-noised measurement has second photon statistics which are better than the first photon statistics.

13. The system of claim 12, the projection data processor, comprising: a log-likelihood processor that determines a most likely decomposition of attenuation for the at least one of the two or more measurements having the first photon statistics based on minimizing a negative log-likelihood of a model of the measurement that incorporates the measurement.

14. The system of claim 13, the projection data processor, comprising: a de-noiser that de-noises the measurement based on the most likely decomposition of attenuation for the at least one of the two or more measurements having the first photon statistics.

15. The system of claim 14, wherein the de-noiser de-noises the measurement by substituting the most likely decomposition of attenuation into the model and computing a measurement that results in the signal, wherein the computed measurement is the de-noised measurement.

16. The system of claim 12, wherein the projection data processor generates de-noised projection data with the de-noised measurement.

17. The system of claim 16, further comprising:
a reconstructor that reconstructs the de-noised projection data generates volumetric image data.

18. The system of claim 17, wherein the reconstructor performs a material-basis decomposition of the image data.

19. The system of claim 12, wherein the system is a computed tomography imaging system.

20. A method, comprising: processing projection data generated by a radiation sensitive detector so as to equalize noise of lower and higher photon statistic spectral measurements of the projection data based on minimizing a likelihood of the projection data in the projection domain.

21. Computer readable instructions encoded on computer readable storage medium, which, when executed by a processor of a computing system causes the processor to:
receive projection data, wherein the projection data is generated by a spectral detector and includes two or more independent energy-resolved measurements in which at least one of the two or more measurements has first photon statistics; and
generate a de-noised measurement in electronic format for the at least one of the two or more measurements having the first photon statistics, wherein the de-noised measurement has second photon statistics which are better than the first photon statistics.
